(19) United States
(12) Patent Application Publication
(10) Pub. No.: US 2025/0209006 A1
(43) Pub. Date: Jun. 26, 2025

(54) PRIME FACTORIZATION HASH OPERATION

(71) Applicant: Advanced Micro Devices, Inc ., Santa Clara, CA (US)

(72) Inventors: Jeffrey Christopher Allan, Boxborough, MA (US); Mark Leather, San Rafael, CA (US)

(73) Assignee: Advanced Micro Devices, Inc., Santa Clara, CA (US)

(21) Appl. No.: 18/390,931

(22) Filed: Dec. 20, 2023

(51) Int. Cl. H04L 9/32

(52) U.S. Cl. CPC H04L 9/3236

(57) ABSTRACT

A technique for improving performance of a hash operation on a processor is provided, in which an input value is hashed into a second value corresponding to a number of bins. The number of bins is an integer that corresponds to a product of first and second integers, the first integer corresponding to a prime number and the second integer corresponding to a power of two. A first modulo hashing operation is performed in which the input value is hashed into the first integer. A second hashing operation is performed using less than all bits of the input value. An output value is formed by concatenating a result of the first hashing operation with a result of the second hashing operation.

### BACKGROUND

Hash functions are a type of mathematical operation used in computing to quickly generate a fixed-size code, known as a hash or checksum, from a variable-length input data. The output, or hash code, is unique to each input. A common method used for hashing is modulo hashing, which involves mapping a key (k) into one of m slots by taking the remainder of k divided by m. A limited category of modulo hash operations are able to be computed quickly by a processor. There exists a need for further modulo hash operations that are able to be performed quickly and efficiently by a processor.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 is a block diagram of the device, illustrating additional details related to execution of processing tasks on the accelerated processing device of FIG. 1, according to an example;

FIG. 3 illustrates operation of a prime factorization hash operation on virtual addresses associated with a cache, according to an example;

FIG. 4, illustrates operation of a prime factorization hash operation on virtual addresses associated with a cache, according to a further example;

FIG. 5 illustrates operation of a prime factorization hash operation applied to bins, according to a further example;

FIG. 6, illustrates operation of a further prime factorization hash operation applied to bins, according to a further example; and

FIG. 7 illustrates a method for performing a prime factorization hash operation, according to an example.

### DETAILED DESCRIPTION

When performing a modulo operation with a power of two, e.g., 2ⁿ, where n is a positive integer, the result is essentially equivalent to keeping only the n least significant bits of the number. For example, if x is 13 (binary: 1101), and n is 3, then (x mod 23) is equivalent to (x AND (2³−1)), which is (1101 AND 1111), resulting in 5 (binary: 101). This bitwise operation is generally more efficient than performing a traditional modulo operation, especially on hardware that supports fast bitwise operations. In contrast, modulo operations with non-powers of two often involve more complex arithmetic, such as division and multiplication, which can be computationally more expensive compared to bitwise operations. Because of this, powers of two for modulo operations are typically used in performance-critical scenarios.

Modulo operations with non-powers of two are believed to require more complex arithmetic operations, which are generally slower. In the prime factorization hash operation described herein, computational efficiency within a processor is achieved in a case where a number is hashed into an integer that is a product of a prime number and a number that is a power of two. The prime factorization hash operation is performed by subdividing the hash operation into a plurality of hash operations (e.g., a first hashing operation and a second hashing operation), each of which is computationally efficient, and then concatenating the results

In this technique an input value is hashed into a second value corresponding to a number of bins. The number of bins is an integer that corresponds to a product of first and second integers, the first integer corresponding to a prime number and the second integer corresponding to a power of two. A processor performs a first hashing operation using a first modulo operation in which the input value is hashed into the first integer. A processor performs a second hashing operation using less than all bits of the input value. An output value is formed by concatenating a result of the first hashing operation with a result of the second hashing operation, the output value corresponding to a hash of the input value into the second value. The prime number is greater than two, and the second integer is greater than one.

Hashing operations are often used in the context of mapping to a cache, where a virtual address is hashed against a set number associated with the hash. In a typical cache hierarchy, data is stored in caches at various levels (e.g., L1 cache, L2 cache). These caches store copies of data from the main memory to speed up data access. However, they often store data using virtual addresses. Use of virtual addresses in caches is used to improve the efficiency of memory access by allowing a processor to operate in a virtualized and isolated environment, while caches optimize data access.

Hashing virtual cache addresses is a technique used in some cache memory designs to efficiently manage the storage and retrieval of data. Reasons for hashing virtual cache addresses in a cache memory system include address mapping, reducing conflicts, and cache set selection. In general, hashing virtual cache addresses is a technique used to optimize cache performance by ensuring a more even distribution of data and minimizing cache conflicts, ultimately improving the overall efficiency of memory access in a computer system.

In a set associative cache, a cache is divided into a number of sets. When a cache lookup occurs (e.g., when a memory access occurs), the cache selects a set within a cache based on certain bits of the address being looked up. In some examples, the techniques described herein are used to hash those bits to perform the set selection. The hash modifies those bits to generate a set identifier and then the cache looks within that set to attempt to find a match (e.g., based on a tag). If a match is found, then there is a cache hit, with subsequent appropriate operations (e.g., read or write). If there is no match, then the cache reads the cache line from a memory that is higher up in the cache hierarchy (e.g., a higher cache level or a non-cache memory).

In some implementations of the disclosed hashing techniques, where an input value is hashed into a second value corresponding to a number of bins, the processor forms a truncated input value by truncating a plurality of least significant bits from the input value, and the second hashing operation comprises a second modulo operation in which the truncated input value is hashed into the second integer. In another implementation, the second hashing operation comprises: for each bit (bₓ) of a plurality of bits in the input value, using a result of (bₓ XOR bₓ₊ₖ), where k is an integer greater than one.

In some implementations, the input value corresponds to a virtual address in a cache, and the second value corresponds to a number of sets in the cache. In some examples, the cache has a number of sets that does not correspond to a power of two. One advantage of the techniques discussed herein is that they accomplish efficient hashing operations in cases where the cache has a number of sets that does not correspond to a power of two. This is advantageous in that it allows a cache size to be stepped, for example, by a step of 16 KB, resulting in “non-power of 2” configurations such as 48 KB, 80 KB, and 96 KB which heretofore were more difficult to hash evenly across a large address range and strided access patterns. In some examples, the processor used to implement the hash operation corresponds to an accelerated processing device (e.g., APD 116) with a plurality of SIMD units 138 that execute the hash operation in parallel.

In some implementations, the computer processor is an accelerated processing device comprised of a plurality of SIMD units that perform the hash function in parallel.

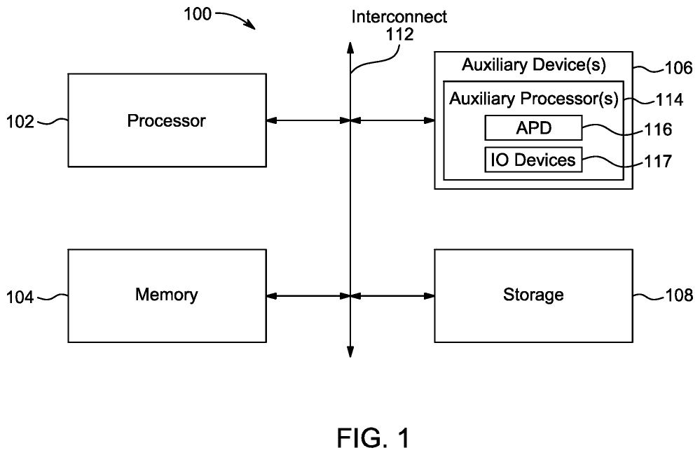

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

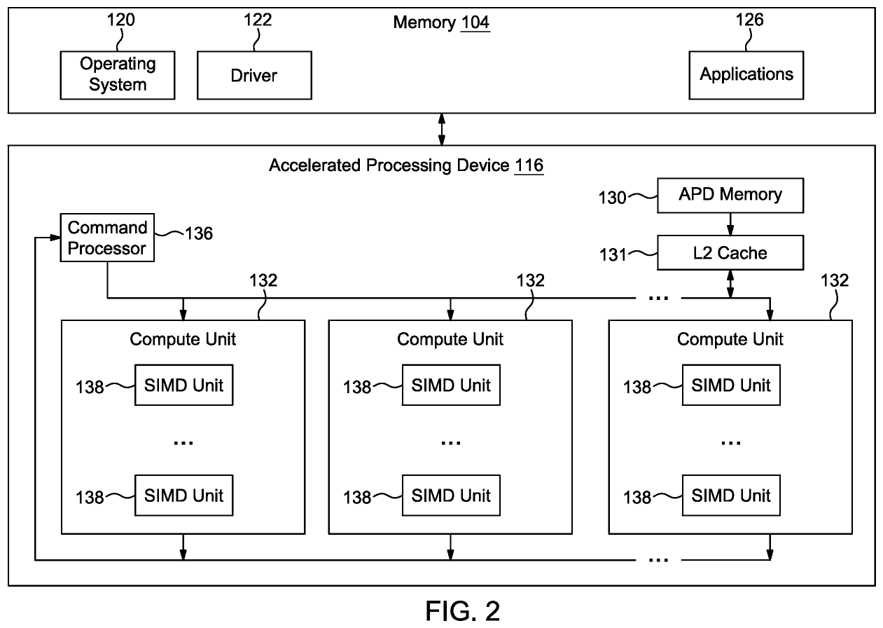

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some implementations, the driver 122 includes a just-in-time compiler that compiles programs for execution by processing components (such as the SIMD units 138 discussed in further detail below) of the APD 116. In other implementations, no just-in-time compiler is used to compile the programs, and a normal application compiler compiles shader programs for execution on the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 has a local cache L1. In an implementation, multiple compute units 132 share an L2 cache 131 which accesses APD memory 130. In some examples, L2 cache 131 is augmented with a hierarchy of cache levels which access APD memory 130.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel on different SIMD units 138. In some examples, wavefronts are the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus, in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

In a typical cache hierarchy, data is stored in caches at various levels (e.g., L1 cache, L2 cache). These caches store copies of data from the main memory to speed up data access. However, they often store data using virtual addresses. Use of virtual addresses in caches is used to improve the efficiency of memory access by allowing a processor to operate in a virtualized and isolated environment, while caches optimize data access.

Hashing operations are often used in graphics processing in the context of mapping to a cache, where a virtual address is hashed against a set number associated with the hash. Hashing virtual cache addresses is a technique used in some cache memory designs to efficiently manage the storage and retrieval of data. Reasons for hashing virtual cache addresses in a cache memory system include address mapping, reducing conflicts, and cache set selection. In general, hashing virtual cache addresses is a technique used to optimize cache performance by ensuring a more even distribution of data and minimizing cache conflicts, ultimately improving the overall efficiency of memory access in a computer system. In a set associative cache, a cache is divided into a number of sets. When a cache lookup occurs (e.g., when a memory access occurs), the cache selects a set within a cache based on certain bits of the address being looked up. In some implementations of the techniques described herein, those bits are hashed to perform the set selection. The hash modifies those bits to generate a set identifier and then the cache looks within that set to attempt to find a match (e.g., based on a tag). If a match is found, then there is a cache hit, with subsequent appropriate operations (e.g., read or write). If there is no match, then the cache reads the cache line from a memory that is higher up in the cache hierarchy (e.g., a higher cache level or a non-cache memory).

Modulo hashing (also called modular hashing) is a simple hash function that operates by taking the remainder of an integer division. A modulo hash begins with a positive integer, typically referred to as the “modulo” value (M). For each key to be hashed, a hash code is determined by taking the remainder of the key's integer value when divided by M. This remainder is the result of the modulo operation. When a processor (e.g., a graphics processor) hashes a large number (such as a large virtual cache address) into a number that is not a power of two (e.g., using a modulo operation), the process is computationally expensive. In an example, hashing a first number into a second number means performing a hash function to generate an output value, where the output value is selected from a set that includes the integers from 0 to the second number. Additionally, hash operations are more computationally efficient in cases where a large number is hashed into either a prime number or a number that is a power of two. In the prime factorization hash operation discussed below, a large number is hashed into an integer that is a product of a prime number and a number that is a power of two. The prime factorization hash operation is performed by subdividing the hash operation into a plurality of hash operations (e.g., a first hashing operation and a second hashing operation), each of which is computationally efficient, and then concatenating the results.

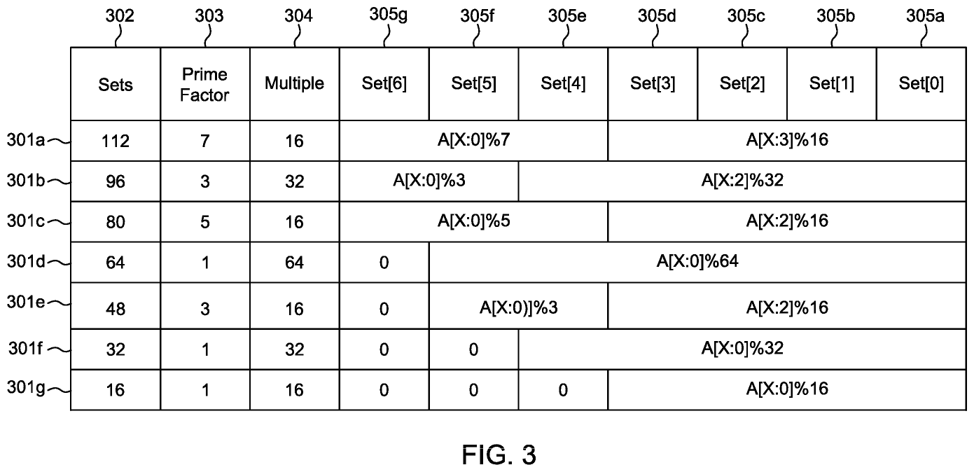

FIG. 3 illustrates operation of a prime factorization hash operation on a virtual address (A) associated with a cache, according to an example. In FIG. 3, each value in column 302 corresponds to a number of sets in a cache. In some examples, a cache controller (which is hardware such as circuitry, including a processor of any technically feasible type, software executing on a processor, or a combination thereof) selects a number of sets with for operation of a cache and operates the cache in accordance with the teachings provided herein. In some examples, a cache is configured in a fixed manner (e.g., at manufacture type) to have a certain number of sets, such as one of the numbers described herein or such as a number that is described in accordance with the teachings here (e.g., a prime number multiplied by a power of two). Each row 301a, 301b, 303c, 303d, 303e, 303f and 303g illustrates a prime factorization hash operation for a hash of A performed for a cache having a given number of sets in the cache. In the example hash operation of FIG. 3, the prime factorization hash operation includes a first hash operation to determine the most significant bits and a second hash operation to determine the rest of the bits. In some examples, and as shown, both the first hash operation and the second hash operation are implemented as a modulo operation.

As shown in columns 303 and 304, each number of sets corresponds to the product of a prime number (column 303) and a number that is a power of 2 (column 304). For example, in row 301a, the number of sets (112) corresponds to a product of a prime number (7) and a power of two (16). Referring still to row 301a, A (the input value, which, in some examples, is derived from at least a portion of the virtual address) is hashed into the value of sets (112), resulting in a 7-bit output value. The value in column 305g (Set[6]) corresponds to the most significant bit (MSB) of the output value; and the values in columns 305f, 305e, 305d, 305c, 305b and 305a correspond to the other bits in the output value in decreasing order of significance, such that the value in column 305a corresponds to the least significant bit (LSB) in the output value.

In the example of row 301a, a processor determines the 3 MSBs of the output value by performing a first hashing operation. In the example illustrated, the first hashing operation comprises a modulo operation. In an example, the first modulo operation is A modulo the prime factor corresponding to the row. In row 301a, this prime factor is 7, so that the modulo operation is A modulo 7. The result of this modulo operation is the 3 most significant bits (“MSBs”) of the output value.

Referring still to FIG. 3, a processor performs the second hashing operation to determine the remaining bits (e.g., four LSBs) of the output value by truncating a plurality of LSBs from the input value to obtain an input value for the second hashing operation, and then performing the second hashing operation on that input value. In the illustrated example, the second hashing operation hashes the second input value with the power of two value of the row (for row 301a, 16).

In one implementation, the processor determines the number of LSBs that are truncated from the input value to obtain the input value for the second hashing operation by rounding a result of log₂ (prime factor) to the nearest integer. For example, for row 301a, prime factor=7, and log₂(7) is approximately 2.8 which rounds to 3. Thus, in this example, the processor truncates the 3 LSBs of the input value to form the truncated input value. Alternatively, the number of LSBs truncated from the input correspond to the number of bits resulting from the hash of the first modulo operation.

Referring now to the example of row 301b, the number of sets (96) corresponds to the product of a prime number (3) and a power of two (32). In row 301b, the input value (A) is hashed into the value of sets (96), resulting in a 7-bit output value. Again, the value in column 305g corresponds to the MSB of the output value; and the values in columns 305f, 305e, 305d, 305c, 305b and 305a correspond to the other bits in the output value in decreasing order of significance, such that the value in column 305a corresponds to the LSB in the output value. In the example of row 301b, a processor determines the 2 MSBs of the output value by performing a first hashing operation that comprises a first modulo operation. In the example, the first modulo operation is A modulo the prime factor (3) of row 301b. A processor performs a second hashing operation to determine the five LSBs of the output value by truncating a plurality of LSBs from the input value to obtain an input value for the second hashing operation, and then performing the second hashing operation on that input value. In the illustrated example, the second hashing operation hashes the second input value with the power of two value of the row (for row 301b, 32). In this example, the processor determines the number of LSBs that are truncated from the input value by rounding a result of log₂(prime factor=3) to the nearest integer (=2). Alternatively, the number of LSBs truncated from the input correspond to the number of bits resulting from the hash of the first modulo operation.

Referring now to the example of row 301c, the number of sets (80) corresponds to the product of a prime number (5) and a power of two (16). In row 301c, A is hashed into the value of sets (80), resulting in a 7-bit output value. Again, the value in column 305g corresponds to the MSB of the output value; and the values in columns 305f, 305e, 305d, 305c, 305b and 305a correspond to the other bits in the output value in decreasing order of significance, such that the value in column 305a corresponds to the LSB in the output value. In the example of row 301c, a processor determines the 3 MSBs of the output value by performing a first hashing operation that comprises a first modulo operation. In the example, the first modulo operation is A modulo the prime factor (5) of row 301c. A processor performs a second hashing operation to determine the 4 LSBs of the output value by truncating a plurality of LSBs from the input value to obtain an input value for the second hashing operation, and then performing the second hashing operation on that input value. In the illustrated example, the second hashing operation hashes the second input value with the power of two value of the row (for row 301c, 16).

Referring now to the example of row 301e, the number of sets (48) corresponds to the product of a prime number (3) and a power of two (16). In row 301e, A is hashed into the value of sets (48), resulting in a 6-bit output value. Here, the value in column 305f corresponds to the MSB of the output value; and the values in columns 305e, 305d, 305c, 305b and 305a correspond to the other bits in the output value in decreasing order of significance, such that the value in column 305a corresponds to the LSB in the output value. In the example of row 301e, a processor determines the 2 MSBs of the output value by performing a first hashing operation that comprises a first modulo operation. In the example, the first modulo operation is A modulo the prime factor (3) of row 301e. A processor performs a second hashing operation to determine the 4 LSBs of the output value by truncating a plurality of LSBs from the input value to obtain an input value for the second hashing operation, and then performing the second hashing operation on that input value. In the illustrated example, the second hashing operation hashes the second input value with the power of two value of the row (for row 301e, 16).

The examples of rows 301d, 301f and 301g correspond to cases where the prime factor is one, and the value of sets is itself a power of two. In these cases, the hash operation is performed in a single step by hashing the input value against the result of a modulo operation where the input value is divided by the number of sets.

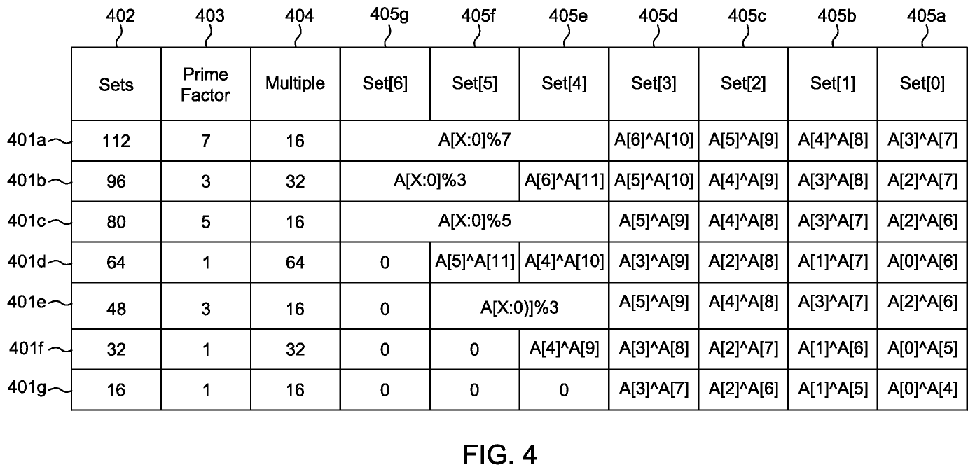

FIG. 4 illustrates operation of a prime factorization hash operation on virtual addresses associated with a cache, according to a further example. In FIG. 4, one or more XOR operations are substituted for the modulo operation applied to the truncated input value described in connection with FIG. 3 (that is, the second hashing operation). In other words, the prime factorization hash operation of FIG. 4 is one in which the first hashing operation is a modulo operation and the second hashing operation is a series of XOR operations. In FIG. 4, each value in column 402 corresponds to a number of sets in a cache. Each row 401a, 401b, 403c, 403d, 403e, 403f and 403g illustrates a prime factorization hash operation where a virtual address (A) is hashed into a given number of sets. As shown in columns 403 and 404, each number of sets corresponds to a product of a prime number (column 403) and a number that is a power of 2 (column 404). The value in column 405g (Set[6]) corresponds to the most significant bit (MSB) of the output value; and the values in columns 405f, 405e, 405d, 405c, 405b and 405a correspond to the other bits in the output value in decreasing order of significance, such that the value in column 405a corresponds to the least significant bit (LSB) in the output value. In the example of row 401a, a processor determines the 3 MSBs of the output value by performing a first hashing operation that comprises a first modulo operation. In the example, the first modulo operation is A modulo the prime factor (7) of row 401a . . . . A processor determines the four LSBs (Set[0], Set[1], Set[2] and Set[3]) of the output value based on the fourth through tenth bits (A[3], A[4] . . . A[10]) of A, as follows: (i) Set[0] is equal to (A[3] XOR A[7]), (ii) Set[1] is equal to (A[4] XOR A[8]), (iii) Set[2] is equal to (A[5] XOR A[9]) and (iv) Set[3] is equal to (A[6] XOR A[9]). In the example of row 401a, determination of the n LSBs of the output value is alternatively represented as follows:

For x=0 to (n−1), Set[x]=(A[x+y−1] XOR A[x+2y−1]), [Equation (1)]
where y=(total number of bits in output value)−(number of bits resulting from first modulo operation)

Alternatively, y is the total number of bits in the output value minus the result of rounding log₂(prime factor) to the nearest integer.

In the example of row 401b, a processor determines the 2 MSBs of the output value by a first modulo hash operation. In the example, the first modulo operation is A modulo the prime factor (3) of row 401b . . . . A processor determines the five LSBs (Set[0], Set[1], . . . Set[4]) of the output value in accordance with Equation (1) where y=5. Similarly, in the example of row 401c, a processor determines the 3 MSBs of the output value by a first modulo hash operation. In the example, the first modulo operation is A modulo the prime factor (5) of row 401c. A processor determines the four LSBs (Set[0], Set[1], . . . Set[3]) of the output value in accordance with Equation (1) where y=4. Finally, in the example of row 401e, a processor determines the 2 MSBs of the output value by a first modulo hash operation. In the example, the first modulo operation is A modulo the prime factor (3) of row 401e. A processor determines the five LSBs (Set[0], Set[1], . . . Set[4]) of the output value in accordance with Equation (1) where y=5.

The examples of rows 401d, 401f and 401g correspond to cases where the prime factor is one, and the value of sets is itself a power of two. In these cases, the hash operation is performed in accordance with equation (2), as follows:

For x=0 to (n−1), Set[x]=hash (A[x] XOR A[x+y]), [Equation (2)]
where y=(total number of bits in output value)

One advantage of the techniques discussed above is that they accomplish efficient hashing operations in cases where the cache has a number of sets that does not correspond to a power of two. This is advantageous in that it allows a cache size to be stepped, for example, by a step of 16 KB, resulting in “non-power of 2” configurations such as 48 KB, 80 KB, and 96 KB which heretofore were more difficult to hash evenly across a large address range and strided access patterns. In some examples, the processor used to implement the hash operation corresponds to an accelerated processing device (e.g., APD 116) with a plurality of SIMD units 138 that execute the hash operation in parallel.

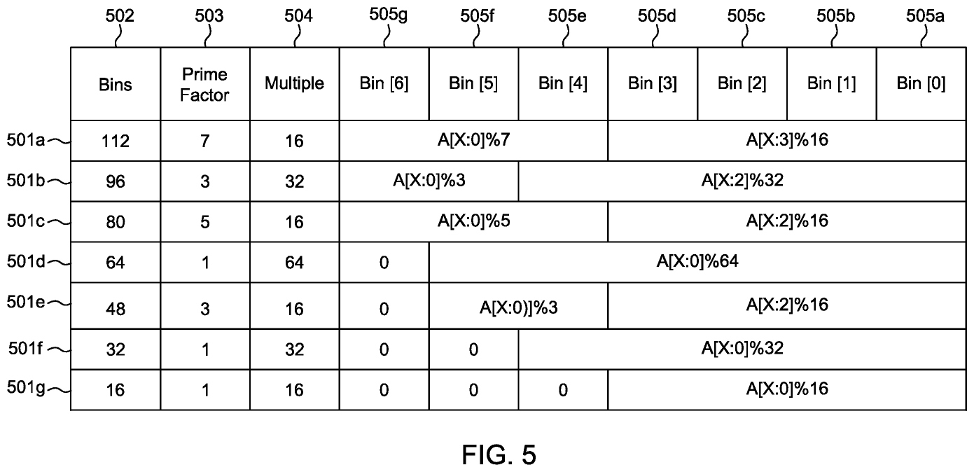

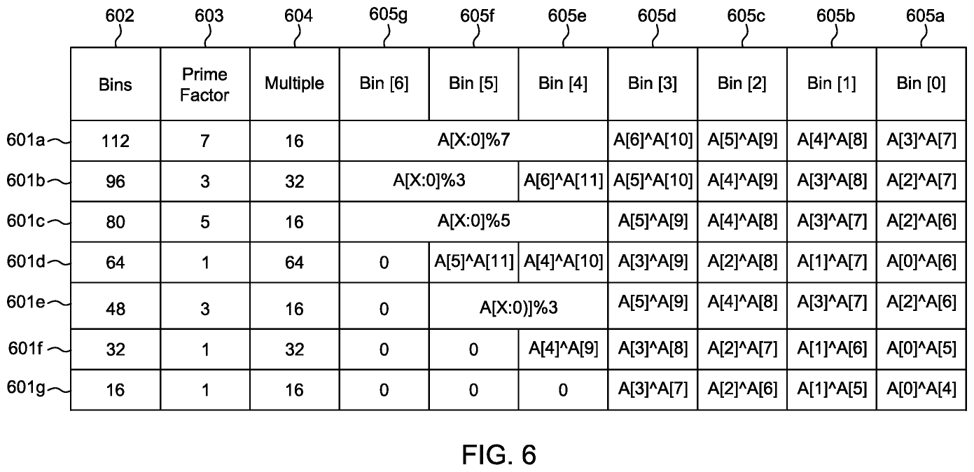

While the examples above are directed to performing hash operations associated with virtual addresses of cache, the techniques set forth herein are not limited to that application. More generally, the techniques apply to applications where any large number (A) is hashed against another number, e.g., a number of bins. In the examples of FIGS. 5 and 6, the large number (A) is not limited to a virtual cache address. In the example of FIG. 5, each value in column 502 corresponds to a number of bins. In the context of hash tables, a bin refers to an individual slot or bucket in the hash table where data elements are stored. Each bin is associated with a specific hash value, and it can contain one or more data items that have the same hash value. A hash table works as follows. The table is capable of storing data items, where each data item includes an index or key as well as a data value. The index is the “lookup” to the table, and the data is the “payload” value. To perform an operation on the hash table, such as a read or a write operation, a hash table controller receives the index value, performs a hashing operation on the index value to obtain a bin identifier, and accesses the data at the identified bin identifier. In some examples, the bin identifiers are arranged in memory in a different order than the index values. A hash table allows for the randomization of placement of data in memory to minimize collisions while still allowing for relatively quick (e.g., less than O(n)) access time. In some examples, the prime factorization hash operation described herein is used to perform this hashing operation to obtain the bin identifier based on the index value. In some examples, the hash table is managed by a hash table controller, which is software, hardware (e.g., a processor of any technically feasible type configured to perform the operations described herein, or a combination thereof). The prime factorization hash operations described herein are applied to increase the efficiency of hashing applications such as data integrity applications (where hash functions are used to verify the integrity of data), cryptographic applications (where hash functions ensure the security and authenticity of data), password storage (where hash functions are used to securely store passwords in databases), digital signatures (where hash functions are used for user authentication), content addressing (where hash functions are used in distributed and peer-to-peer systems for content addressing), file deduplication (where hash functions are used to identify duplicate files in storage systems), data fingerprinting (where hash functions are used to create unique fingerprints for data) and blockchain technology (where hash functions are used to link blocks of transactions, ensuring the security and immutability of the blockchain.)

Referring to FIG. 5, each row 501a, 501b, 503c, 503d, 503e, 503f and 503g illustrates a prime factorization hash operation where A is hashed into a given number of bins. The value in column 505g (Bin[6]) corresponds to the most significant bit (MSB) of the output value; and the values in columns 505f, 505e, 505d, 505c, 505b and 505a correspond to the other bits in the output value in decreasing order of significance, such that the value in column 505a corresponds to the least significant bit (LSB) in the output value. As shown in columns 503 and 504, each number of sets corresponds to a product of a prime number (column 503) and a number that is a power of 2 (column 504). With the exception of generalizing the sets from FIG. 3 to bins in FIG. 5, the hashing operations in FIG. 5 function the same as those described above in connection with FIG. 3.

Similar to FIG. 5, FIG. 6 illustrates operation of a prime factorization hash operation according to a further example where a large number (A) is hashed into a number of bins. In FIG. 6, each value in column 602 corresponds to a number of bins in a hash table. Each row 601a, 601b, 603c, 603d, 603e, 603f and 603g illustrates a prime factorization hash operation where a value (A) is hashed into a given number of bins. As shown in columns 603 and 604, each number of bins corresponds to a product of a prime number (column 603) and a number that is a power of 2 (column 604). The value in column 605g (Bin[6]) corresponds to the most significant bit (MSB) of the output value; and the values in columns 605f, 605e, 605d, 605c, 605b and 605a correspond to the other bits in the output value in decreasing order of significance, such that the value in column 605a corresponds to the least significant bit (LSB) in the output value. With the exception of generalizing the sets from FIG. 4 to bins in FIG. 6, the hashing operations in FIG. 6 function the same as those described above in connection with FIG. 4.

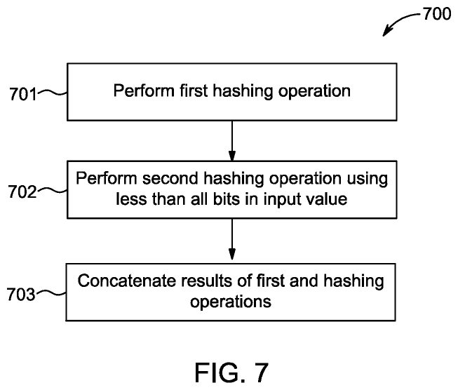

FIG. 7 illustrates a method 700 for performing a prime factorization hash operation on a processor in which an input value is hashed into a second value corresponding to a number of bins in a hash table. The number of bins is an integer that corresponds to a product of first and second integers, the first integer corresponding to a prime number and the second integer corresponding to a power of two. In step 701, the processor performs a first hashing operation. In one implementation, the first hashing operation is first modulo operation in which the input value is hashed into the first integer in step 702, the processor performs a second hashing operation using less than all bits of the input value. In step 703, the processor forms an output value by concatenating a result of the first hashing operation with a result of the second hashing operation, the output value corresponding to a hash of the input value into the second value. In method 700, the prime number is greater than two, and the second integer is greater than one.

In one implementation of step 702, the processor forms a truncated input value formed by truncating a plurality of least significant bits from the input value, and the second hashing operation comprises a second modulo operation in which the truncated input value is hashed into the second integer. In another implementation of step 702, the second hashing operation comprises: for each bit (bₓ) of a plurality of bits in the input value, the result equals (bₓ XOR bₓ₊ₖ), where k is an integer greater than one

In some implementations, the input value corresponds to a virtual address in a cache, and the second value corresponds to a number of sets in the cache. In some examples, the cache has a size that does not correspond to a power of two.

In some implementations, the computer processor is an accelerated processing device comprised of a plurality of SIMD units that perform the hash function in parallel.

In some examples, the prime factorization hash techniques described herein are used to hash virtual address bit of an associative cache to perform the set selection. The hash modifies those bits to generate a set identifier and then the cache looks within that set to attempt to find a match (e.g., based on a tag). If a match is found, then there is a cache hit, with subsequent appropriate operations (e.g., read or write). If there is no match, then the cache reads the cache line from a memory that is higher up in the cache hierarchy (e.g., a higher cache level or a non-cache memory).

In other examples, the prime factorization hash operations described herein are applied to increase the efficiency of other hashing applications such as data integrity applications (where hash functions are used to verify the integrity of data), cryptographic applications (where hash functions ensure the security and authenticity of data), password storage (where hash functions are used to securely store passwords in databases), digital signatures (where hash functions are used for user authentication), content addressing (where hash functions are used in distributed and peer-to-peer systems for content addressing), file deduplication (where hash functions are used to identify duplicate files in storage systems), data fingerprinting (where hash functions are used to create unique fingerprints for data) and blockchain technology (where hash functions are used to link blocks of transactions, ensuring the security and immutability of the blockchain.)

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, or SIMD units 138, are implemented fully in hardware, fully in software executing on processing units, or as a combination thereof. In various examples, such “hardware” includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
performing a hash function that hashes an input value into a second value corresponding to a number of bins, wherein the number of bins is an integer that corresponds to a product of first and second integers, the first integer corresponding to a prime number and the second integer corresponding to a power of two, where performing the hash function includes:
performing a first modulo hashing operation in which the input value is hashed into the first integer;
performing a second hashing operation using less than all bits of the input value; and
forming an output value by concatenating a result of the first modulo hashing operation with a result of the second hashing operation, the output value corresponding to a hash of the input value into the second value;
wherein the prime number that is greater than two, and the second integer is greater than one; and
performing a lookup operation that comprises performing a bin selection in accordance with the output value.

2. The method of claim 1, further comprising forming a truncated input value formed by truncating a plurality of least significant bits from the input value, wherein the second hashing operation comprises a second modulo hashing operation in which the truncated input value is hashed into the second integer.

3. The method of claim 1, wherein the second hashing operation comprises: for each bit (bₓ) of a plurality of bits in the input value, performing the following XOR operation: bₓ XOR bₓ₊ₖ, where k is an integer greater than one.

4. The method of claim 1, wherein the lookup operation comprises performing a set selection in accordance with the output value.

5. The method of claim 4, wherein the input value corresponds to a virtual address in a cache associated with a graphics processor.

6. The method of claim 5, wherein the second value corresponds to a number of sets in the cache.

7. The method of claim 6, wherein the cache has a size that does not correspond to a power of two.

8. The method of claim 1, wherein a plurality of SIMD units perform the hash function in parallel.

9. A system, comprising:
a memory; and
a processor configured to perform a hash function that hashes an input value into a second value corresponding to a number of bins for data stored in the memory, wherein the number of bins is an integer that corresponds to a product of first and second integers, the first integer corresponding to a prime number and the second integer corresponding to a power of two, where performing the hash function includes:
performing a first modulo hashing operation in which the input value is hashed into the first integer;
performing a second hashing operation using less than all bits of the input value; and
forming an output value by concatenating a result of the first modulo hashing operation with a result of the second hashing operation, the output value corresponding to a hash of the input value into the second value;
wherein the prime number that is greater than two, and the second integer is greater than one; and
wherein said processor is further configured to perform a lookup operation that comprises performing a bin selection in accordance with the output value.

10. The system of claim 9, wherein the processor is further configured to form a truncated input value formed by truncating a plurality of least significant bits from the input value, wherein the second hashing operation comprises a second modulo hashing operation in which the truncated input value is hashed into the second integer.

11. The system of claim 9, wherein the second hashing operation comprises: for each bit (bₓ) of a plurality of bits in the input value, performing the following XOR operation: bₓ XOR bₓ₊ₖ, where k is an integer greater than one.

12. The system of claim 9, wherein the lookup operation comprises performing a set selection for a set associative cache stored in the memory in accordance with the output value.

13. The system of claim 12, wherein the memory comprises a cache associated with a graphics processor, and the input value corresponds to a virtual address in the cache.

14. The system of claim 13, wherein the second value corresponds to a number of sets in the cache.

15. The system of claim 14, wherein the cache has a size that does not correspond to a power of two.

16. The system of claim 9, wherein a plurality of SIMD units are operable to perform the hash function in parallel.

17. A non-transitory computer-readable medium storing instructions that, when executed by a processor, cause the processor to perform operations comprising:
performing a hash function that hashes an input value into a second value corresponding to a number of bins, wherein the number of bins is an integer that corresponds to a product of first and second integers, the first integer corresponding to a prime number and the second integer corresponding to a power of two, where performing the hash function includes:
performing a first modulo hashing operation in which the input value is hashed into the first integer;
performing a second hashing operation using less than all bits of the input value; and
forming an output value by concatenating a result of the first modulo hashing operation with a result of the second hashing operation, the output value corresponding to a hash of the input value into the second value;
wherein the prime number that is greater than two, and the second integer is greater than one; and
performing a lookup operation that comprises performing a bin selection in accordance with the output value.

18. The non-transitory computer-readable medium of claim 17, wherein the operations further comprise forming a truncated input value formed by truncating a plurality of least significant bits from the input value, wherein the second hashing operation comprises a second modulo hashing operation in which the truncated input value is hashed into the second integer.

19. The non-transitory computer-readable medium of claim 17, wherein the second hashing operation comprises: for each bit (bₓ) of a plurality of bits in the input value, performing the following XOR operation: bₓ XOR bₓ₊ₖ, where k is an integer greater than one.

20. The non-transitory computer-readable medium of claim 17, wherein the lookup operation comprises performing a set selection in accordance with the output value.
